(19) United States
(12) Patent Application Publication
(10) Pub. No.: US 2025/0143260 A1
(43) Pub. Date: May 8, 2025

(54) Spill-Proof Pet Bowl Device

(71) Applicants: Matt Brady, Howard, OH (US); Abe Rabers, Howard, OH (US)

(72) Inventors: Matt Brady, Howard, OH (US); Abe Rabers, Howard, OH (US)

(21) Appl. No.: 18/940,338

(22) Filed: Nov. 7, 2024

Related U.S. Application Data
(60) Provisional application No. 63/596,767, filed on Nov. 7, 2023.

(51) Int. Cl. A01K 5/01; A01K 7/00

(52) U.S. Cl. CPC A01K 5/0135; A01K 7/005

(57) ABSTRACT

A spill-proof pet bowl device is provided. The device is comprised of a base that can be secured to a surface via at least one fastener or wherein movement of the base along a surface is minimized via a grip material or a weight. The base receives at least one lid with a drinking opening. The perimeter of the opening is comprised of a bevel that prevents water from spilling out of the device in the event that the device is flipped. In one embodiment, the base may receive at least one insert that concentrates liquid within the base below the opening.

### CROSS-REFERENCE TO RELATED APPLICATION

The present application claims priority to, and the benefit of, U.S. Provisional Application No. 63/596,767, which was filed on Nov. 7, 2023, and is incorporated herein by reference in its entirety.

### FIELD OF THE INVENTION

The present invention relates generally to the field of pet bowls. More specifically, the present invention relates to a spill-proof pet bowl device with a base designed to prevent movement/tipping and a lid with a drinking opening with a beveled perimeter that prevents water from spilling out of the device in the event that the device is spilled. Accordingly, the present disclosure makes specific reference thereto. Nonetheless, it is to be appreciated that aspects of the present invention are also equally applicable to other like applications, devices, and methods of manufacture.

### BACKGROUND

When drinking water from a bowl, pets often accidentally tip over the bowl, causing water to spill on the floor. This not only creates a mess but can also lead to water damage on various floor surfaces if it happens repeatedly. More importantly, if pets do not have consistent access to water due to such spills, they risk dehydration. Dehydration in pets can lead to significant health problems, potentially requiring costly veterinary treatments. Ensuring pets have continuous access to water is crucial for their well-being and to avoid the inconvenience and expense of water damage and health issues.

Therefore, there exists a long-felt need in the art for an improved pet bowl. There also exists a long-felt need in the art for a spill-proof pet bowl device. More specifically, there exists a long-felt need in the art for a spill-proof pet bowl device wherein the device cannot be easily moved, tipped, or spilled. Further, there exists a long-felt need in the art for a spill-proof pet bowl device wherein the device cannot be easily moved, tipped, or spilled and wherein the device retains liquid within the device in the event that it is moved, tipped, or spilled.

The subject matter disclosed and claimed herein, in one embodiment thereof, comprises a spill-proof pet bowl device. The device is comprised of a base that can be secured to a surface via at least one fastener or wherein movement of the base along a surface is minimized via a grip material or a weight. The base receives at least one lid with a drinking opening. The perimeter of the opening is comprised of a bevel that prevents water from spilling out of the device in the event that the device is flipped. In one embodiment, the base may receive at least one insert that concentrates liquid within the base below the opening.

In this manner, the spill-proof pet bowl device of the present invention accomplishes all the foregoing objectives and provides an improved pet bowl. More specifically, the device provides a spill-proof pet bowl device wherein the device cannot be easily moved, tipped, or spilled. Further, the device retains liquid within the device in the event that it is moved, tipped, or spilled via the bevel of the perimeter edge of the opening.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a spill-proof pet bowl device. The device is comprised of a base and at least one lid that removably or fixedly attaches to the base. The lid is further comprised of an opening with a perimeter edge comprised of at least one bevel. The device may be made from any material known in the art such as, but not limited to, plastic or metal in different embodiments.

The bottom surface of the base may be comprised of at least one grip material that prevents the bottom surface from sliding/flipping. In a different embodiment, the bottom surface (or any surface of the base) is comprised of at least one fastener such as, but not limited to, an adhesive, a suction cup, a magnet, etc., to allow the bottom surface to be attached to a surface to prevent sliding/flipping of the base. In a further embodiment, the base may be comprised of at least one weight. The weight prevents the sliding/flipping of the base.

The device is also comprised of at least one lid that attaches to the base in a removable fashion. The lid is comprised of a top wall with at least one opening that allows an animal to drink from the base. In one embodiment, the opening is comprised of a perimeter edge comprised of a bevel (wherein the bevel forms an angle less than 90 degrees with the edge). The bevel prevents water from leaking out of the device from the opening in the event that the device is knocked over.

In one embodiment, the device is comprised of at least one insert comprised of at least one sidewall that forms a cone or triangular prism-like shape. The sidewalls facilitate easier drinking of water from the base by concentrating the location of the water underneath the opening (as opposed to the interior of the entire base as would occur in an embodiment of the device without the insert).

The present invention is also comprised of a method of using the device. First, a device is provided comprised of a base and a lid that attaches to the base, the top wall of the lid is comprised of at least one opening that may or may not have a perimeter edge with at least one bevel. Then, the base can be placed on a surface. In one embodiment, the base is comprised of at least one weight. In another embodiment, the bottom surface of a bottom wall of the base is comprised of a non-slip material. In one embodiment, the bottom surface is comprised of at least one fastener wherein a user can attach the bottom surface to the surface via the fastener. Next, the lid can be attached to the base via snapping the lid onto the base or by at least one fastener. Finally, the base can be filled with water or other liquid.

The present invention is also comprised of a second method of using the device. First, a device is provided comprised of a base, an insert, and a lid that attaches to the base, the top wall of the lid is comprised of at least one opening that may or may not have a perimeter edge with at least one bevel. Then, the base can be placed on a surface. In one embodiment, the base is comprised of at least one weight. In another embodiment, the bottom surface of a bottom wall of the base is comprised of a non-slip material. In one embodiment, the bottom surface is comprised of at least one fastener wherein a user can attach the bottom surface to the surface via the fastener. Next, the insert can be placed into the base wherein a perimeter edge attaches to the base via snapping the edge onto the base and/or at least one fastener. Then, the lid can be attached to the base via snapping the lid onto the base or by at least one fastener. Finally, the base can be filled with water or other liquid.

Accordingly, the spill-proof pet bowl device of the present invention is particularly advantageous as it provides an improved pet bowl. More specifically, the device provides a spill-proof pet bowl device wherein the device cannot be easily moved, tipped, or spilled. Further, the device retains liquid within the device in the event that it is moved, tipped, or spilled via the bevel of the perimeter edge of the opening. In this manner, the spill-proof pet bowl device overcomes the limitations of existing pet bowls known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a side-exploded view of one potential embodiment of a spill-proof pet bowl device of the present invention in accordance with the disclosed architecture;

FIG. 2 illustrates a perspective view of one potential embodiment of a spill-proof pet bowl device of the present invention while unassembled in accordance with the disclosed architecture;

FIG. 3 illustrates a bottom perspective view of an insert of one potential embodiment of a spill-proof pet bowl device of the present invention in accordance with the disclosed architecture;

FIG. 4 illustrates a top view of one potential embodiment of a spill-proof pet bowl device of the present invention while assembled in accordance with the disclosed architecture;

FIG. 5 illustrates a flowchart of a method of using one potential embodiment of a spill-proof pet bowl device of the present invention in accordance with the disclosed architecture; and

FIG. 6 illustrates a flowchart of a method of using one potential embodiment of a spill-proof pet bowl device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved pet bowl. There also exists a long-felt need in the art for a spill-proof pet bowl device. More specifically, there exists a long-felt need in the art for a spill-proof pet bowl device wherein the device cannot be easily moved, tipped, or spilled. Further, there exists a long-felt need in the art for a spill-proof pet bowl device wherein the device cannot be easily moved, tipped, or spilled and wherein the device retains liquid within the device in the event that it is moved, tipped, or spilled.

The present invention, in one exemplary embodiment, is comprised of a spill-proof pet bowl device comprised of a base and at least one lid that removably or fixedly attaches to the base. The lid is further comprised of an opening with a perimeter edge comprised of at least one bevel. The device may be made from any material known in the art such as, but not limited to, plastic or metal in different embodiments.

The bottom surface of the base may be comprised of at least one grip material that prevents the bottom surface from sliding/flipping. In a different embodiment, the bottom surface (or any surface of the base) is comprised of at least one fastener such as, but not limited to, an adhesive, a suction cup, a magnet, etc., to allow the bottom surface to be attached to a surface to prevent sliding/flipping of the base. In a further embodiment, the base may be comprised of at least one weight. The weight prevents the sliding/flipping of the base.

The device is also comprised of at least one lid. The lid attaches to the base in a removable fashion. The lid is comprised of a top wall with at least one opening that allows an animal to drink from the base. In one embodiment, the opening is comprised of a perimeter edge comprised of a bevel (wherein the bevel forms an angle less than 90 degrees with the edge). The bevel prevents water from leaking out of the device from the opening in the event that the device is knocked over.

In one embodiment, the device is comprised of at least one insert comprised of at least one sidewall that forms a cone or triangular prism-like shape. The sidewalls facilitate easier drinking of water from the base by concentrating the location of the water underneath the opening (as opposed to the interior of the entire base as would occur in an embodiment of the device without the insert).

The present invention is also comprised of a method of using the device. First, a device is provided comprised of a base and a lid that attaches to the base, the top wall of the lid is comprised of at least one opening that may or may not have a perimeter edge with at least one bevel. Then, the base can be placed on a surface. In one embodiment, the base is comprised of at least one weight. In another embodiment, the bottom surface of a bottom wall of the base is comprised of a non-slip material. In one embodiment, the bottom surface is comprised of at least one fastener wherein a user can attach the bottom surface to the surface via the fastener. Next, the lid can be attached to the base via snapping the lid onto the base or by at least one fastener. Finally, the base can be filled with water or other liquid.

The present invention is also comprised of a second method of using the device. First, a device is provided comprised of a base, an insert, and a lid that attaches to the base, the top wall of the lid is comprised of at least one opening that may or may not have a perimeter edge with at least one bevel. Then, the base can be placed on a surface. In one embodiment, the base is comprised of at least one weight. In another embodiment, the bottom surface of a bottom wall of the base is comprised of a non-slip material. In one embodiment, the bottom surface is comprised of at least one fastener wherein a user can attach the bottom surface to the surface via the fastener. Next, the insert can be placed into the base wherein a perimeter edge attaches to the base via snapping the edge onto the base and/or at least one fastener. Then, the lid can be attached to the base via snapping the lid onto the base or by at least one fastener. Finally, the base can be filled with water or other liquid.

Accordingly, the spill-proof pet bowl device of the present invention is particularly advantageous as it provides an improved pet bowl. More specifically, the device provides a spill-proof pet bowl device wherein the device cannot be easily moved, tipped, or spilled. Further, the device retains liquid within the device in the event that it is moved, tipped, or spilled via the bevel of the perimeter edge of the opening. In this manner, the spill-proof pet bowl device overcomes the limitations of existing pet bowls known in the art.

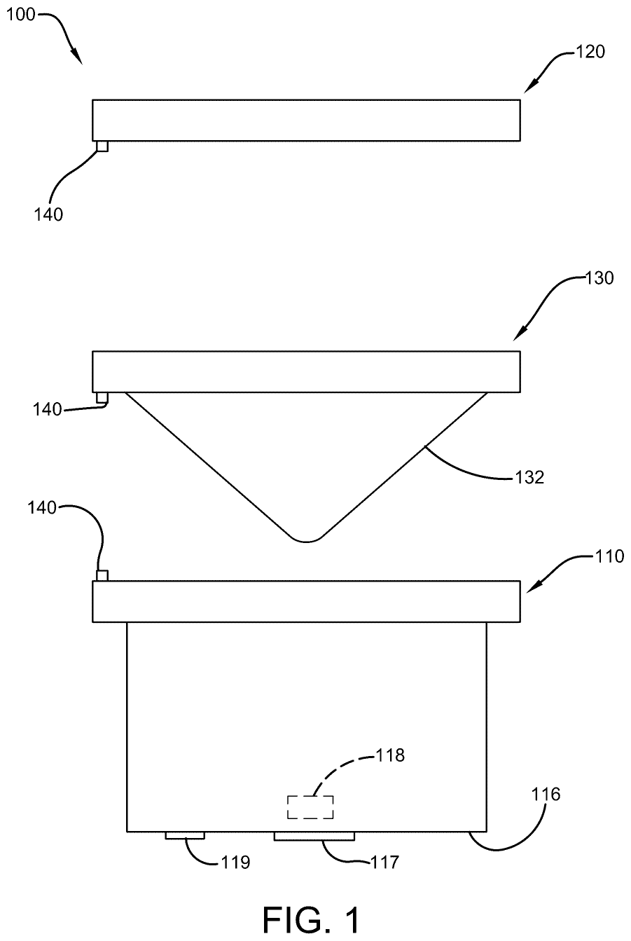

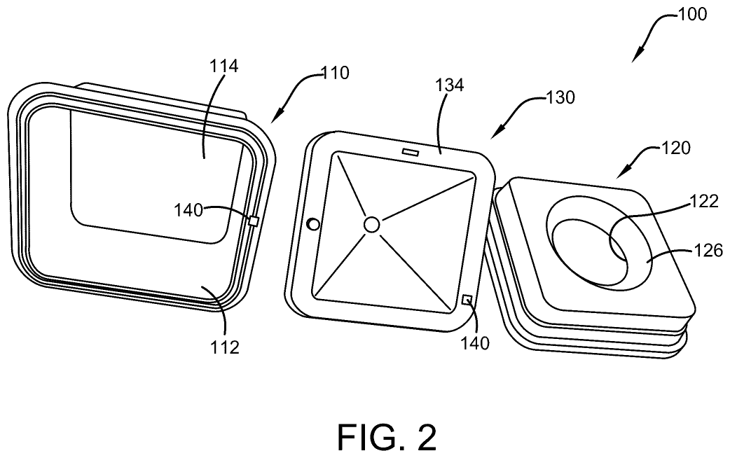

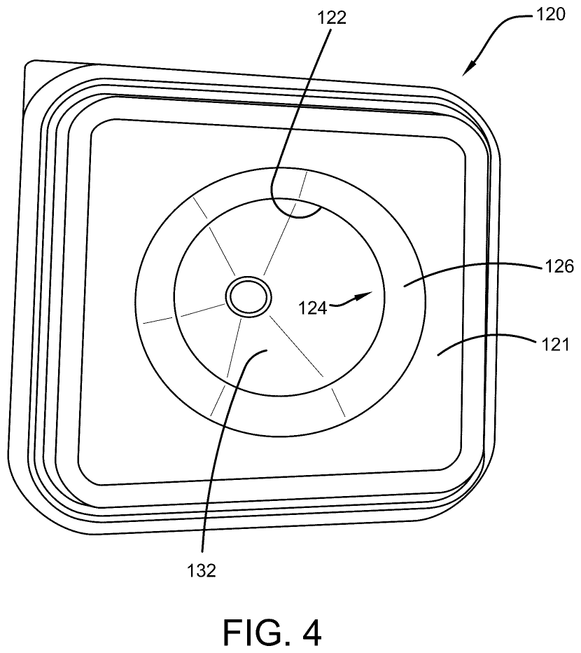

Referring initially to the drawings, FIG. 1 illustrates a side-exploded view of one potential embodiment of a spill-proof pet bowl device 100 of the present invention in accordance with the disclosed architecture. The device 100 is comprised of a base 110 and at least one lid 120 that removably or fixedly attaches to the base 110, wherein the lid 120 is comprised of an opening 122 with a perimeter edge 124 comprised of at least one bevel 126, as also seen in FIG. 2 and FIG. 4. The device 100 may be made from any material known in the art such as, but not limited to, plastic or metal in different embodiments.

The base 110 of the device 100 is preferably square but may be any shape in different embodiments. In a square embodiment, the base 110 is comprised of two sets of parallel side walls 112 and a bottom wall 114. The bottom surface 116 of the bottom wall 114 may be comprised of at least one grip material 117. The grip material 117 prevents the bottom surface 116 from sliding/flipping. The grip material 117 may include, but is not limited to, a textured rubber or other non-slip material of the like. In a different embodiment, the bottom surface 116 (or any surface of the base 110) is comprised of at least one fastener 119 such as, but not limited to, an adhesive, a suction cup, a magnet, etc., to allow the bottom surface 116 to be attached to a surface to prevent sliding/flipping of the base 110. In a further embodiment, the base 110 may be comprised of at least one weight 118. The weight 118 prevents the sliding/flipping of the base 110.

The device 100 is also comprised of at least one lid 120. The lid 120 attaches to the base 110 in a removable fashion during the use of the device 100. In one embodiment, the lid 120 snaps onto the base 110. In another embodiment, the lid 120 (and/or base 110) may be comprised of at least one fastener 140 that allows the lid 120 and base 110 to removably attach. Said fastener 140 includes, but is not limited to, magnet, tongue and groove, threaded fasteners, clips, clamps, locking fasteners, etc.

The lid 120 is comprised of a top wall 121 with at least one opening 122 that allows an animal to drink from the base 110. In one embodiment, the opening 122 is comprised of a perimeter edge 124 comprised of a bevel 126 (wherein the bevel forms an angle less than 90 degrees with the edge 124). The bevel 126 prevents water from leaking out of the device 100 from the opening 122 in the event that the device 100 is knocked over.

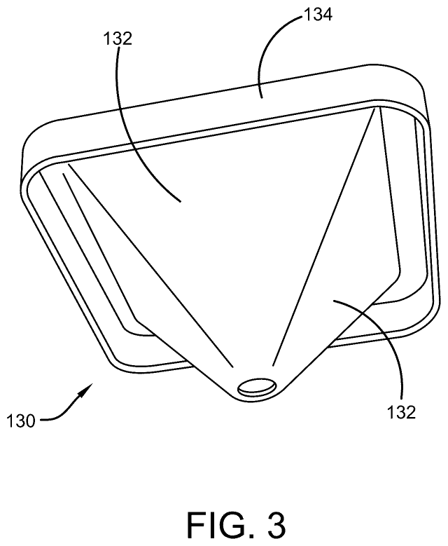

In one embodiment, the device 100 is comprised of at least one insert 130, as seen in FIG. 3. The insert 130 is comprised of a perimeter lip 134 that allows the insert 130 to be snapped over the base 110. Then, the lid 120 can be snapped over the lip 134. In one embodiment, the lip 134 (and/or lid 120 and base 110) may be comprised of at least one fastener 140 that allows the lid 120 and base 110 to removably attach. Said fastener 140 includes, but is not limited to, magnet, tongue and groove, threaded fasteners, clips, clamps, locking fasteners, etc.

The insert 130 is comprised of at least one sidewall 132 that forms a cone or triangular prism-like shape. The sidewalls 132 facilitate easier drinking of water from the base 110 by concentrating the location of the water underneath the opening 122 (as opposed to the interior of the entire base 110 as would occur in an embodiment of the device 100 without the insert 130).

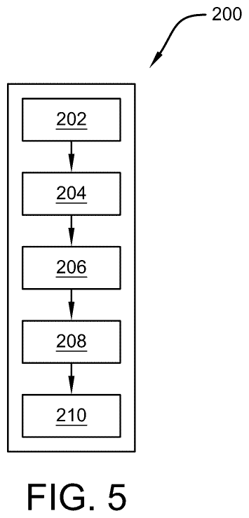

The present invention is also comprised of a method of using 200 the device 100, as seen in FIG. 5. First, a device 100 is provided comprised of base 110 and a lid 120 that attaches to the base 110, the top wall 121 of the lid 120 comprised of at least one opening 122 that may or may not have a perimeter edge 124 with at least one bevel 126 [Step 202]. Then, the base 110 can be placed on a surface [Step 204]. In one embodiment, the base 110 is comprised of at least one weight 118. In another embodiment, the bottom surface 116 of a bottom wall 114 of the base 110 is comprised of a non-slip material 117. In one embodiment, the bottom surface 116 is comprised of at least one fastener 119 wherein a user can attach the bottom surface 116 to the surface via the fastener 119 [Step 206]. Next, the lid 120 can be attached to the base 110 via snapping the lid 120 onto the base 110 or by at least one fastener 140 [Step 208]. Finally, the base 110 can be filled with water or other liquid [Step 210].

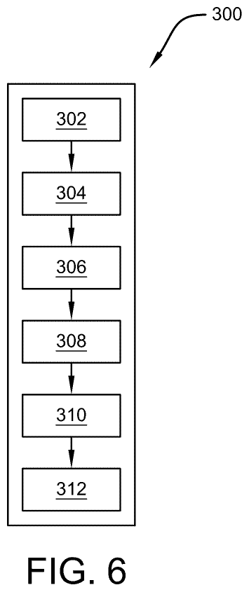

The present invention is also comprised of a second method of using 300 the device 100, as seen in FIG. 6. First, a device 100 is provided comprised of base 110, an insert 130, and a lid 120 that attaches to the base 110, the top wall 121 of the lid 120 is comprised of at least one opening 122 that may or may not have a perimeter edge 124 with at least one bevel 126 [Step 202]. Then, the base 110 can be placed on a surface [Step 204]. In one embodiment, the base 110 is comprised of at least one weight 118. In another embodiment, the bottom surface 116 of a bottom wall 114 of the base 110 is comprised of a non-slip material 117. In one embodiment, the bottom surface 116 is comprised of at least one fastener 119 wherein a user can attach the bottom surface 116 to the surface via the fastener 119 [Step 206]. Next, the insert 130 can be placed into the base 110 wherein a perimeter edge 134 attaches to the base via snapping the edge 134 onto the base 110 and/or at least one fastener 140 [Step 308]. Then, the lid 120 can be attached to the base 110 via snapping the lid 120 onto the base 110 or by at least one fastener 140 [Step 310]. Finally, the base 110 can be filled with water or other liquid [Step 312].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “spill-proof pet bowl device” and “device” are interchangeable and refer to the spill-proof pet bowl device 100 of the present invention.

Notwithstanding the foregoing, the spill-proof pet bowl device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the spill-proof pet bowl device 100 as shown in the FIGS. are for illustrative purposes only, and that many other sizes and shapes of the spill-proof pet bowl device 100 are well within the scope of the present disclosure. Although the dimensions of the spill-proof pet bowl device 100 are important design parameters for user convenience, the spill-proof pet bowl device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A spill-proof pet bowl device comprising:
a base comprised of a bottom wall and a side wall; and
a lid comprised of an opening comprised of a perimeter edge comprised of a bevel.

2. The spill-proof pet bowl device of claim 1, wherein the base is comprised of a weight.

3. The spill-proof pet bowl device of claim 1, wherein the base is comprised of a fastener.

4. The spill-proof pet bowl device of claim 3, wherein the fastener is comprised of an adhesive, a suction cup, or a magnet.

5. The spill-proof pet bowl device of claim 3, wherein the fastener is positioned on a bottom surface of the bottom wall.

6. The spill-proof pet bowl device of claim 1, wherein the lid removably attaches to the base.

7. The spill-proof pet bowl device of claim 5, wherein the lid removably attaches to the base via a fastener.

8. The spill-proof pet bowl device of claim 1, wherein a bottom surface of the bottom wall of the base is comprised of a grip material.

9. The spill-proof pet bowl device of claim 8, wherein the grip material is comprised of a non-slip, textured material.

10. A spill-proof pet bowl device comprising:
a base comprised of a bottom wall and a side wall;
an insert; and
a lid comprised of an opening comprised of a perimeter edge comprised of a bevel.

11. The spill-proof pet bowl device of claim 10, wherein the insert is comprised of a cone shape.

12. The spill-proof pet bowl device of claim 10, wherein the insert is comprised of a triangular prism shape.

13. The spill-proof pet bowl device of claim 10, wherein the insert attaches to the base.

14. The spill-proof pet bowl device of claim 13, wherein the lid attaches to the insert.

15. The spill-proof pet bowl device of claim 10, wherein the base is comprised of a weight.

16. The spill-proof pet bowl device of claim 10, wherein the base is comprised of a fastener.

17. The spill-proof pet bowl device of claim 16, wherein the fastener is comprised of an adhesive, a suction cup, or a magnet.

18. The spill-proof pet bowl device of claim 16, wherein the fastener is positioned on a bottom surface of the bottom wall.

19. A method of using a spill-proof pet bowl device, the method comprising the following steps:
providing a spill-proof pet bowl device comprised of a base and a lid that attaches to the base, a top wall of the lid comprised of an opening with a perimeter edge comprised of a bevel;
placing the base on a surface;
attaching the lid to the base; and
filling the base with a liquid.

20. The method of using a spill-proof pet bowl device of claim 19 further comprised of a step of attaching an insert to the base and then attaching the lid to the insert.
